(19) United States
(12) Patent Application Publication
(10) Pub. No.: US 2014/0047930 A1
(43) Pub. Date: Feb. 20, 2014

(54) MONITORING DEVICE FOR MONITORING CLEANING ACTIVITY

(71) Applicant: The Procter & Gamble Company, Cincinnati, OH (US)

(72) Inventors: Tobias Joachim Schädel, Bad Homburg (DE); Kris Lückel, Schwalbach am Tanus (DE); Benjamin Heinrich Niestroj, Konigstein im Taunus (DE); Baptiste Pommiers, Etterbeek (BE); Bart Van De Putte, Strombeek Bever (BE); Robby Renilde Francois Keuleers, Lippelo (BE)

(73) Assignee: The Procter & Gamble Company, Cincinnati, OH (US)

(21) Appl. No.: 13/966,319

(22) Filed: Aug. 14, 2013

Related U.S. Application Data
(60) Provisional application No. 61/684,170, filed on Aug. 17, 2012.

(51) Int. Cl. G01L 1/04

(52) U.S. Cl. CPC G01L 1/04
USPC 73/862.637

(57) ABSTRACT

A monitoring device for monitoring a user's cleaning activity, comprising a squeezable housing and a sensor housed within the housing, wherein the sensor is configured to sense at least pressure exerted to the monitoring device by the user during the cleaning activity.

### FIELD OF THE INVENTION

The present invention relates to a monitoring device capable of monitoring a user's cleaning activity and a cleaning implement comprising the monitoring device.

### BACKGROUND OF THE INVENTION

Consumer studies are extensively used in the development of consumer products. For example, in the development of dishwashing products, consumer studies investigate consumers' cleaning activities by monitoring the usage of a cleaning implement, such as a sponge, scrub, cleaning cloth, and the like. Indeed, it is important to accurately measure and record the user's movement during a cleaning activity to ensure the consumer study is effective. Thus, there is a need to provide a monitoring device capable of monitoring a user's cleaning activity accurately.

It is an advantage of the present invention to provide a monitoring device capable of monitoring a user's cleaning activity accurately without causing an unnatural or negative feeling to the user during the cleaning activity.

### SUMMARY OF THE INVENTION

In one aspect, the present invention is directed to a monitoring device for monitoring a user's cleaning activity, comprising a squeezable housing and a sensor housed within the housing, wherein the sensor is configured to sense at least pressure exerted to the monitoring device by the user during the cleaning activity.

In another aspect, the present invention is directed to a cleaning implement comprising the monitoring device.

In yet another aspect, the present invention is directed to a method of monitoring a user's cleaning activity, comprising the steps:
a) providing a cleaning implement comprising the monitoring device to the user;
b) having the user clean with the cleaning implement;
c) collecting sensor data via the sensor from the user's cleaning activity;
d) retrieving the collected sensor data; and
e) analyzing the retrieved sensor data to monitor the user's cleaning activity.

### BRIEF DESCRIPTION OF THE DRAWINGS

FIG. 1 is an isometric view of a monitoring device according to one preferred embodiment of the present invention.

FIG. 2 is an isometric view of a monitoring device according to another preferred embodiment of the present invention.

FIG. 3 is an isometric view of a cleaning implement according to yet another embodiment of the present invention.

### DETAILED DESCRIPTION OF THE INVENTION

### Monitoring Device

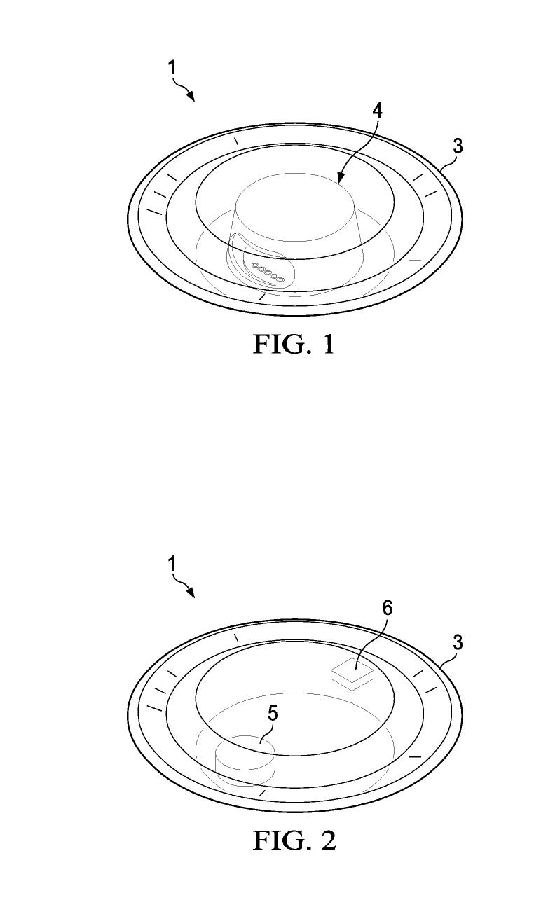

FIG. 1 shows a preferred embodiment of the monitoring device 1 of the present invention. The monitoring device 1 herein comprises a squeezable housing 3 and a sensor 4 housed within the housing 3. The sensor 4 is configured to sense at least pressure exerted to the monitoring device 1 by the user during a cleaning activity. The term “cleaning activity”, as used herein, refers to removing impurities or soils from an object or surface, e.g., a user uses a sponge to clean a dishware or hard surface.

### Housing

The monitoring device 1 of the present invention comprises a squeezable housing 3. The housing 3 houses a sensor 4. The term “squeezable”, as used herein, refers to being capable of compressing under pressure and decompressing after the pressure is removed. The amount of the pressure is the typical pressure exerted by a user during a cleaning activity. Such a squeezable housing has a squeezed state under pressure, e.g., under the pressure exerted by a user during a cleaning activity, and is able to recover to a non-squeezed state when the pressure is removed, e.g., the cleaning activity finished. During the cleaning activity, the squeezable housing 3 enables the sensor 4 therein to sense the impact of the environment with improved accuracy, particularly enables a pressure sensor 5 to sense the pressure exerted to the monitoring device 1 with improved accuracy due to a relatively close distance to the user, e.g., the hand of the user. Furthermore, the squeezable housing 3 does not cause an unnatural or negative feeling to the user due to its squeezed state during the cleaning activity.

The squeezable housing 3 is generally “air tight” and not rupturable under typical cleaning activities and under typical atmospheric conditions. When a user exerts pressure to the monitoring device 1, the user will also necessarily exert pressure to the squeezable housing 3, thereby increasing the air pressure in the internal volume of the housing 3 that the housed sensor 4 senses. When the user stops exerting pressure to the monitoring device, the air pressure within the squeezable housing 3 decreases that is also sensed by the housed sensor 4. One skilled in the art can readily extrapolate the pressure sensed by the housed sensor 4 and the pressure exerted by the user to the monitoring device 1.

The housing 3 herein may be filled with a medium material selected from the group consisting of air, inert gas, inert liquid, and a mixture thereof. Preferably, the medium material is air, thus delivering a housing having a better squeezable property. In one embodiment, the internal pressure of the housing 3 (in its non-squeezed state) is greater than the atmospheric pressure for the purpose of providing a more uniform shape to the housing 3.

The housing 3 herein may have a wall made of an elastic material. The elastic material may be selected from the group consisting of polyethylene, polyester, polyamide, polypropylene, polystyrene, polycarbonate, polyethylene terephthalate, natural rubber, styrene-butadiene rubber, polybutadiene rubber, ethylene/propylene rubber, butyl- and chloro-butyl rubber, polyisoprene, nitrile and polyacrylate rubbers, silicone rubber, fluorocarbon rubbers, urethane elastomers, and/or latex or foam rubber, mixtures thereof, and laminates thereof. In one embodiment, the housing wall has an overall thickness of from 50 μm to 120 μm, preferably from 80 μm to 100 μm.

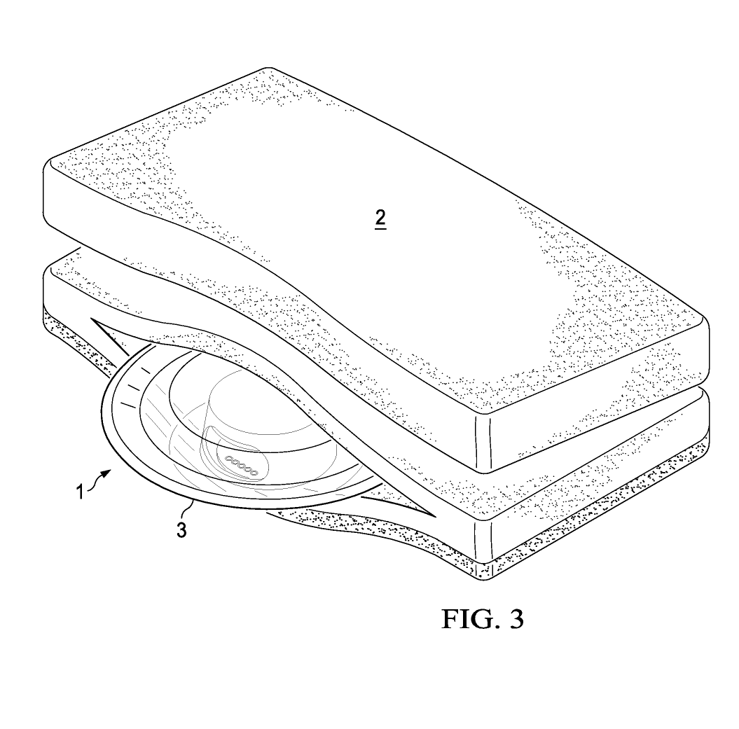

The housing 3 herein can be of any shape depending on applications. The housing 3 is preferably in the form of a closed shape, i.e., “air tight”, more preferably a symmetrical and closed shape. Such a closed shaped housing 3 facilitates the housed sensor 4 to sense the impact of the environment while protecting the sensor 4 from potential damages due to environmental exposure. In one embodiment, the housing 3 is in the form of a cubic shape or rounded shape. Preferably, the housing is in the form of a rounded shape selected from the group consisting of sphere, oval, and a combination thereof, more preferably a closed, rounded shape, as shown in FIGS. 1 and 2. Without wishing to be bound by theory, it is believed that a rounded shaped housing minimizes the difference in detecting forces from various directions upon the monitoring device 1 for which monitoring is sought. Accordingly, it is possible to monitor the force upon the monitoring device 1 regardless of its direction. It also provides the flexibility in monitoring device, housing and/or sensor design, i.e., the sensor 4 can almost be housed anywhere inside the housing 3.

The housing 3 herein can be configured to have essentially internal volume depending on applications. The internal volume may change depending on the externally exerted pressure to the housing 3, i.e., the internal volume generally decreases upon external pressure to the housing 3 and increases when the external pressure is removed. The housing 3 is preferably configured to have an internal volume, in a non-squeezed state, larger than the size of the housed sensor 4. In one embodiment, the housing 3 is configured to have an internal volume, in a non-squeezed state, of from 0.1 cm³ to 500 cm³, preferably from 0.3 cm³ to 50 cm³, more preferably from 1 cm³ to 10 cm³. In a preferred embodiment, the housing 3 is configured in the form of a closed shape to have an internal volume, in a non-squeezed state, of from 0.1 cm³ to 500 cm³, preferably from 0.3 cm³ to 50 cm³, more preferably from 1 cm³ to 10 cm³.

The housing 3 herein may be a one-piece structure, but preferably it is a two or more-piece structure such that the internal components can be accessed and/or replaced from time to time. In one embodiment, the housing 3 is made by joining two halves together, wherein each half is a mirror image of the other half.

### Sensor

The monitoring device 1 of the present invention comprises a sensor 4 housed within the housing 3, wherein the housed sensor 4 is configured to sense at least pressure exerted to the monitoring device by a user during a cleaning activity by measuring the change in the pressure within the squeezable housing 3. Preferably, the sensor 4 is further configured to sense displacement of the monitoring device during a cleaning activity. The sensor 4 provides sensor data.

In one embodiment, the sensor 4 is selected from the group consisting of a pressure sensor 5, acceleration sensor 6, velocity sensor, vibration sensor, agitation sensor, strain sensor, temperature sensor, and a combination thereof. The sensor 4 herein may be either a single sensor capable of sensing two or more functions or a plurality of separate sensors each with its unique function. Commercially available sensors suitable for the sensor 4 of the present invention may be obtained from several suppliers, including, but not limited to: Orion, Honeywell, Rosemont, Microsensors Inc., TBI-Bailey, Foxboro, Sentron, WTI Inc., Hanna Instruments, Sensor-Tech, Lazar Labs, Onset Computer Corp and Gemini.

In one embodiment, the monitoring device 1 herein comprises a pressure sensor 5, preferably a piezoelectric pressure sensor. In a preferred embodiment, the housing 3 has a wall defining an internal volume, wherein the housing wall has an inner surface facing the internal volume, and wherein the pressure sensor 5 is not attached to the inner surface of the housing wall.

In another embodiment, the monitoring device 1 herein comprises an acceleration sensor 6. The acceleration sensor 6 is configured to sense displacement and acceleration along one or more axes, e.g., along the X, Y, Z axis. Preferably, the acceleration sensor 6 is attached to the inner surface of the housing wall.

In a preferred embodiment, the monitoring device 1 herein comprises at least two sensors 4. Preferably, the monitoring device 1 herein comprises at least two sensors 4, a pressure sensor 5 and a second sensor selected from the group consisting of an acceleration sensor 6, velocity sensor, vibration sensor, agitation sensor, strain sensor, temperature sensor, and a combination thereof. Alternatively, the monitoring device 1 comprises 3, 4, 5 or more sensors 4.

In a highly preferably embodiment, the monitoring device 1 comprises two sensors 4, a pressure sensor 5 and an acceleration sensor 6. Even more preferably, the pressure sensor 5 is not attached to the inner surface of the housing wall, and the acceleration sensor 6 is attached to the inner surface of the housing wall, as shown in FIG. 2. The monitoring device 1 herein is capable of simultaneously sensing the pressure exerted to the monitoring device 1 and the displacement of the monitoring device 1. Without wishing to be bound by theory, during a cleaning activity, pressure and displacement are among the two most significant factors that impact cleaning performance, and they are inversely proportional. Specifically, when a user uses a monitoring device to clean a surface and exerts increased pressure to the monitoring device, the displacement of the monitoring device along the surface decreases, and vice versa. Moreover, either an increased pressure exerted to the monitoring device or an increased displacement of the monitoring device is directly related to a user's greater effort to remove soils, thus leading to an improved cleaning performance. Thus, such a monitoring device comprising a pressure sensor and an acceleration sensor enables improved accuracy in monitoring the user's cleaning activity as well as measuring the user's effort to remove soils.

The sensor 4 herein can be of any size known in the art. It is preferable that the sensor 4 of the present invention is compact and portable, thus not causing an unnatural or negative feeling to users during a cleaning activity. In one embodiment, the sensor 4 has a size of from 0.05 cm³ to 50 cm³, preferably from 0.1 cm³ to 10 cm³, more preferably from 0.5 cm³ to 1 cm³. In another embodiment, the internal volume of the housing 3 in a non-squeezed state is configured to be from 2, alternatively 3, 4, or 5 times to 20 times larger than the size of the sensor 4 housed within the housing 3. Without wishing to be bound by theory, a relatively large internal volume allows for greater precision in measuring pressure changes within the housing 3 by the housed sensor 4. However, a too large internal volume of a housing may lead to an unnatural feel or look to the user given the large size of the housing. In a preferred embodiment, the housing 3 is configured to have an internal volume of from 0.1 cm³ to 500 cm³ in a non-squeezed state, and the sensor 4 has a size of from 0.05 cm³ to 50 cm³. In a more preferred embodiment, the housing 3 is configured to have an internal volume of from 0.3 cm³ to 50 cm³ in a non-squeezed state, and the sensor 4 has a size of from 0.1 cm³ to 10 cm³. In an even more preferred embodiment, the housing 3 is configured to have an internal volume of from 1 cm³ to 10 cm³ in a non-squeezed state, and the sensor 4 has a size of from 0.5 cm³ to 1 cm³.

### Monitoring Unit

The sensor 4 of the present invention is preferably the component of a monitoring unit. The monitoring unit is housed within the housing 3. In one embodiment, the monitoring unit herein further comprises a recording component in electric communication with the sensor 4. The recording component is configured to record data, including the sensor data measured by the sensor 4. The term “data” herein refers to information, especially information organized for analysis, including but not limited to physical parameter, chemical parameter, temperature, time, date, and a combination thereof. The monitoring unit may further comprise a power supply. The power supply provides current to power the sensor 4, the recording component, and other possible components of the monitoring unit. The monitoring unit may further comprise a light emitting diode (LED) to indicate the sensor 4's operational status. Preferably, the monitoring unit comprises a power supply and a recording component in electric communication with the sensor 4.

The power supply herein is renewable and may be selected from a battery, a solar power means, or a rechargeable system. When a battery is selected for employment in the monitoring unit, such a battery may either be rechargeable or disposable in nature.

The LED herein may facilitate the display of at least two functions: data-acquisition mode and standby mode. In one embodiment, the LED indicates the status of the sensor 4, whether in data-acquisition mode or standby mode, via a constant or flashing single-colored light. For example, the constant illumination of a red light via the display means indicates that the sensor 4 is in standby mode. Conversely, the flashing of said red light via the display means indicates that the sensor 4 is in data-acquisition mode. In another embodiment, the LED indicates the operational status of the sensor 4 via the employment of a distinctive color for each operational status. For example, a green light may be illuminated on the LED when the sensor 4 is in data-acquisition mode. Conversely, a red light may be illuminated when the sensor 4 is in standby mode.

### Recording Component

The monitoring unit of the present invention may further comprise a recording component in electric communication with the sensor 4. The recording component of the present invention preferably comprises one or more of the following constituents: a memory means, a microcontroller, an analog-to-digital converter and a digital input/output.

The recording component herein may comprise a memory means. The memory means is either a volatile memory or a non-volatile memory, or a combination thereof. As used herein, the term “volatile memory” refers to a computer memory that retains the stored information even when not powered, and the term “non-volatile memory” refers to a computer memory that requires power to maintain the stored information, i.e., the stored information is lost when power supply is off. Preferably, the sensor data is stored in a volatile memory. In one embodiment, the memory means comprises at least about 32 kilobytes of space, more preferably at least about 64 kilobytes. In another embodiment, the monitoring unit comprises a memory means that is employed to store the sensor data for later access by the microcontroller. In yet another embodiment, the memory means is employed to store the software and/or variables with which the microcontroller is controlled. Preferably, the microcontroller uses a non-volatile ROM memory to execute a previously stored program and uses a volatile memory to store temporary variables during program execution.

The recording component herein may comprise a microcontroller. The microcontroller stores data to and reads data from the memory means. Preferably, the microcontroller comprises a timer to measure the duration of the sensor data. More preferably, the microcontroller further comprises a timer/counter unit. When present, the timer/counter unit enables the microcontroller to index the sensor data as a function of the time and date when the microcontroller receives the sensor data. That is to say, the timer/counter unit controls and documents the frequency with which a function is sensed and/or recorded. Of course, users of the monitoring unit will know the time at which the monitoring unit is employed in the environment for which measurement is sought. Nevertheless, by using the timer/counter unit, users may further determine the exact time at which a particular function was measured. Without wishing to be bound by theory, this may be achieved by correlating the time of deployment of the monitoring unit into the subject environment with the frequency of measurement set by the timer/counter unit of the monitoring unit.

The recording component herein may comprise an analog-to-digital converter. The analog-to-digital converter converts the sensor data from analog to digital form. Preferably, the analog-to-digital is characterized by a signal strength of about 12 bits, more preferably 16 bits. The analog-to-digital converter serves the additional purpose of providing an accurate data measurement, while facilitating the employment of simple circuitry for use. In one embodiment, the analog-to-digital converter transmits the converted data in digital form to the digital input/output.

The recording component herein may comprise a digital input/output. The digital input/output receives data in digital form from the sensor 4 or from the analog-to-digital converter. When transferred in digital form, the sensor data may be transferred to a computer or similar device only to effectuate meaningful presentation of the sensor data, e.g., being transferred to a computer for presentation in Microsoft® Excel. Otherwise, the sensor data possesses a form that is suitable for immediate interpretation by the practitioner of the monitoring device 1. In yet another preferred embodiment, the sensor 4 transmits data in analog form to the analog-to-digital converter, and then the converted data in digital form is transmitted from the analog-to-digital converter to the digital input/output.

In one embodiment, the data collection rate of the recording component may be programmed to suit the needs of the users. Preferably, the data collection rate of the recording component is relatively low, preferably as short as one-tenth of a second. A low data collection rate is particularly useful when temporary storage of data in the recording component is appropriate.

The recording component herein may comprise one or more processors. The number of functions stored by the recording component is entirely dependent on the type of processor employed in the monitoring unit. Indeed, there exist several, commercially available processors, each of which is designed to store a varying amount of data. A practitioner may select the appropriate processor for employment in the monitoring unit depending on the duration of the intended deployment(s) and the number of functions for which measurement is sought. Preferably, the monitoring unit comprises a processor adapted to record all of the functions associated with a single deployment, thereby eliminating the need to retrieve recorded data from the monitoring unit before the completion of an intended deployment.

### Cleaning Implement

One aspect of the present invention is directed to a cleaning implement 2 comprising the monitoring device 1, wherein the monitoring device 1 is integrated within the cleaning implement 2.

The cleaning implement 2 herein can be any object suitable for household cleaning, including but not limited to a sponge, scrub, cleaning cloth, or a combination thereof. The cleaning implement 2 may further comprise handles or poles or other similar components that are functionally attached to the sponge, scrub, etc. The cleaning implement 2 may be disposable or non-disposable or a combination thereof. For example, the cleaning implement 2 may be a toilet scrubber with a disposable scrubbing head wherein the scrubbing head is replaced after each use. Preferably, the cleaning implement 2 is a sponge, more preferably a sponge comprising an isotropic material. The term “isotropic” herein means having substantially uniform physical properties in all directions.

The monitoring device 1 can be integrated anywhere within the cleaning implement 2, e.g., completely enclosed in the cleaning implement 2, or located in a center area of the cleaning implement 2. In one embodiment, the monitoring device 1 is located within the sponge, preferably in a center area of the sponge, as shown in FIG. 3. Preferably, the sponge comprises at least two layers, more preferably two layers, wherein the monitoring device 1 is located between the two layers. Alternatively, the sponge comprises two layers, and each layer of the sponge has a material removed corresponding to a respective half of the housing 3, such that the monitoring device 1 can be located between the two layers in the void created by the removed sponge material. Such an arrangement of the sponge ensures that the sponge has a shape that users are typically accustomed to, i.e., the sponge does not have a bulge when the monitoring device 1 is integrated. Of course in some embodiments, the monitoring device 1 is small enough as to noticeably alter the shape or feel of the sponge so that it is not necessary to remove sponge material to accommodate the housing. In one embodiment, the sponge material comprises a melamine-based foam. See US2007-0166488.

### Method of Monitoring Cleaning Activity

One aspect of the present invention is directed to a method of monitoring a user's cleaning activity using the cleaning implement 2 of the present invention. The method comprises the steps:
a) providing the cleaning implement 2 of the present invention to a user;
b) having the user clean with the cleaning implement 2;
c) collecting sensor data via said sensor from the user cleaning;
d) retrieving the collected sensor data; and
e) analyzing the retrieved sensor data to monitor the user's cleaning activity.

In one embodiment, step a) further comprises providing the monitoring device 1 of the present invention to the user, and the user integrating the monitoring device 1 within a traditional cleaning implement, e.g. a traditional sponge he is using, thus forming the inventive cleaning implement 2. In an alternative embodiment, step a) further comprises providing the cleaning implement 2 of the present invention directly to the user, without requiring additional steps for the user to form the inventive cleaning implement 2.

In a preferred embodiment, step c) further comprises collecting sensor data sensed by a pressure sensor 5 and an acceleration sensor 6. Preferably, step e) further comprises analyzing the sensor data sensed by the pressure sensor 5 and the acceleration sensor 6 to measure the user's effort to remove soils from a target surface.

Users may activate the sensor 4 of the present invention either manually or automatically. In one embodiment, the sensor 4 activates automatically upon sensing a predetermined value. For example, the monitoring device 1 may only collect data after the pressure sensor 5 senses a threshold level of pressure thereby indicating that the cleaning implement 2 is being used by the user. One benefit of this automatic approach is that it avoids the user from remembering to turn on or off a switch, or be reminded that his/her cleaning activity is being monitored thereby arguably biasing the consumer study. Upon the sensor 4 sensing a predetermined value, the recording component may activate to record the sensor data. Such an automatic sensing feature facilitates the conservation of power and memory, such that the recording component only stores meaningful sensor data. Thus, the automatic sensing feature maximizes the storage of meaningful data, particularly in comparison with conventional monitoring units. In an alternative embodiment, the sensor 4 is manually activated.

In one embodiment, the sensor 4, upon activation, continues to acquire data until a predetermined time period has elapsed or an event has stopped. In another embodiment, the sensor 4, upon activation, continues to collect data from a user's cleaning activity until such data reaches a predetermined value, at which time the sensor 4 enters standby mode. The sensor 4 may remain in the monitoring device 1 in which it is deployed for a predetermined time period or until the sensor data no longer meets the threshold required for data-acquisition mode.

In one embodiment, step d) further comprises removing the monitoring device 1 from the cleaning implement 2. Preferably, the monitoring device 1 is removed from the cleaning implement 2 in which it is deployed upon the duration of the predetermined time period or deactivation of the sensor 4, e.g., indicated via the LED. Upon removal of the monitoring device 1 from the cleaning implement 2, the practitioner may engage in the retrieval of the information recorded by the sensor 4.

In an alternative embodiment, step d) further comprises wirelessly retrieving the collected sensor data from the monitoring device 1, without removing the monitoring device 1 from the cleaning implement 2. That is to say, in the case of a consumer testing environment, it is possible to retrieve the sensor data from the monitoring device 1 during use or before the consumer returns the monitoring device 1 or the cleaning implement 2. Moreover, a wireless means avoids destroying the monitoring device 1 in order to retrieve the sensor data from the sensor 4. The wireless means herein can be of any suitable means known in the art, including but not limited to: electronic means, radio frequency means, and infrared (IR) means.

Unless otherwise indicated, all percentages, ratios, and proportions are calculated based on weight of the total composition. All temperatures are in degrees Celsius (° C.) unless otherwise indicated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A monitoring device for monitoring a user's cleaning activity, comprising: a squeezable housing and a sensor housed within said housing, wherein said sensor is configured to sense at least pressure exerted to the monitoring device by the user during the cleaning activity.

2. The monitoring device according to claim 1, wherein said sensor is further configured to sense displacement of the monitoring device during the cleaning activity.

3. The monitoring device according to claim 1 or 2, wherein said housing has a wall made of an elastic material.

4. The monitoring device according to claim 1 or 2, wherein said sensor is selected from the group consisting of a pressure sensor, acceleration sensor, velocity sensor, vibration sensor, agitation sensor, strain sensor, temperature sensor, and a combination thereof.

5. The monitoring device according to claim 4, comprising at least two sensors, preferably said at least two sensors comprise a pressure sensor and an acceleration sensor.

6. The monitoring device according to claim 5, wherein said housing has a wall defining an internal volume, wherein said housing wall has an inner surface facing the internal volume, and wherein said pressure sensor is not attached to said inner surface of said housing wall and said acceleration sensor is attached to said inner surface of said housing wall.

7. The monitoring device according to claim 1, wherein said housing is configured to have an internal volume, in a non-squeezed state, of from 0.1 cm³ to 500 cm³, preferably from 0.3 cm³ to 50 cm³, more preferably from 1 cm³ to 10 cm³.

8. The monitoring device according to claim 1 or 7, wherein said sensor has a size of from 0.05 cm³ to 50 cm³, preferably from 0.1 cm³ to 10 cm³, more preferably from 0.5 cm³ to 1 cm³.

9. The monitoring device according to claim 3, wherein said elastic material is selected from the group consisting of polyethylene, polyester, polyamide, polypropylene, polystyrene, polycarbonate, polyethylene terephthalate, natural rubber, styrene-butadiene rubber, polybutadiene rubber, ethylene/propylene rubber, butyl- and chloro-butyl rubber, polyisoprene, nitrile and polyacrylate rubbers, silicone rubber, fluorocarbon rubbers, urethane elastomers, and/or latex or foam rubber, mixtures thereof, and laminates thereof.

10. The monitoring device according to claim 9, wherein said housing wall has an overall thickness of from 50 μm to 120 μm, preferably from 80 μm to 100 μm.

11. The monitoring device according to claim 1, wherein said housing is filled with a medium material selected from the group consisting of air, inert gas, inert liquid, and a mixture thereof, preferably said medium material is air.

12. The monitoring device according to claim 1, wherein said housing is in a rounded shape selected from the group consisting of sphere, oval, and a combination thereof, preferably said housing is in a closed, rounded shape.

13. The monitoring device according to claim 1, wherein said sensor is the component of a monitoring unit, wherein said monitoring unit: comprises a recording component in electric communication with said sensor; and is housed in said housing.

14. A cleaning implement comprising the monitoring device according to any one of claims 1-13, wherein the monitoring device is integrated within the cleaning implement.

15. The cleaning implement according to claim 14, wherein the cleaning implement is selected from a sponge, scrub, or cleaning cloth, or a combination thereof, preferably a sponge.

16. The cleaning implement according to claim 15, wherein the monitoring device is located within said sponge, preferably said sponge comprises two layers, and the monitoring device is located between said two layers.

17. A method of monitoring a user's cleaning activity comprising the steps:
a) providing the cleaning implement according to any one of claims 14-16 to the user;
b) having the user clean with the cleaning implement;
c) collecting sensor data via said sensor from the user cleaning;
d) retrieving the collected sensor data; and
e) analyzing the retrieved sensor data to monitor the user's cleaning activity.

18. The method according to claim 17, wherein step c) further comprises collecting sensor data sensed by a pressure sensor and an acceleration sensor.

19. The method according to claim 17, wherein step d) further comprises removing the monitoring device from the cleaning implement.

20. The method according to claim 17, wherein step d) further comprises wirelessly retrieving the collected sensor data from the monitoring device.
